(19) United States
(12) Patent Application Publication
(10) Pub. No.: US 2013/0208470 A1
(43) Pub. Date: Aug. 15, 2013

(54) ILLUMINATION APPARATUS AND LIGHT EMITTING DEVICE THEREOF

(71) Applicants: DONGGUAN MASSTOP LIQUID CRYSTAL DISPLAY CO., LTD., (US); WINTEK CORPORATION, (US)

(72) Inventors: Zhi-Ting Ye, Miaoli County (TW); Chin-Liang Chen, Taichung City (TW); Ming-Chuan Lin, Taichung City (TW); Tang-Hao Weng, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/742,367

(22) Filed: Jan. 16, 2013

(30) Foreign Application Priority Data
Feb. 10, 2012 (TW) 101202455

(51) Int. Cl. F21V 8/00; F21V 29/00

(52) U.S. Cl. CPC G02B 6/0096; F21V 29/22; F21V 29/2275
USPC 362/235

(57) ABSTRACT

An illumination apparatus includes a light emitting device and a fluorescent lamp base having first and second sockets. The light emitting device is disposed on the fluorescent lamp base and includes a light guide bar, first and second plug structures, and a first LED assembly. The light guide bar has first and second ends corresponding to the first and second plug structures respectively. The first and second plug structures are respectively disposed on the first and second ends of the light guide bar for electrically connecting to the first and second sockets respectively. The first LED assembly is disposed in the first plug structure and has two first cables. The two first cables are electrically connected to the first and second plug structures respectively, so as to make the first LED assembly receive power provided by the fluorescent lamp base for emitting light to the light guide bar.

### BACKGROUND OF THE INVENTION

1. Field of the Invention

The present invention relates to an illumination apparatus and a light emitting device thereof, and more specifically, to an illumination apparatus utilizing cables of a light emitting diode assembly to electrically connect to plug structures respectively for making a light emitting device capable of being directly installed on a fluorescent lamp base and a light emitting device thereof.

2. Description of the Prior Art

In general, a conventional illumination apparatus usually utilizes a fluorescent lamp as a light source. In recent years, for achieving the environmental protection and energy saving purposes, the fluorescent lamp has gradually been replaced by a light emitting device composed of a light guide bar and light emitting diodes (LED) disposed on two ends of the light guide bar. However, since a conventional fluorescent lamp base has a live wire socket and a neutral wire socket respectively disposed on its two ends for electrically connecting to lamp caps of a fluorescent lamp, the light emitting diode can not be coupled to the live wire socket and the neutral wire socket simultaneously if the light emitting device is directly installed on the fluorescent lamp base. Under this circumstance, the light emitting diodes are incapable of emitting light. That is to say, the light emitting device is not suitable for a conventional fluorescent lamp base, meaning that the light emitting device can only be installed on a lamp base with a specific circuit configuration. Thus, application of the light emitting device is greatly limited.

### SUMMARY OF THE INVENTION

The present invention provides an illumination apparatus including a fluorescent lamp base and a light emitting device. The fluorescent lamp base has a first socket and a second socket for providing power. The light emitting device is disposed on the fluorescent lamp base and includes a light guide bar, a first plug structure, a second plug structure, and a first LED assembly. The light guide bar has a first end and a second end corresponding to the first socket and the second socket respectively. The first plug structure is disposed on the first end of the light guide bar for electrically connecting to the first socket. The second plug structure is disposed on the second end of the light guide bar for electrically connecting to the second socket. The first LED assembly is disposed in the first plug structure and has two first cables. The two first cables are coupled to the first plug structure and the second plug structure respectively, so as to make the first LED assembly receive power provided by the fluorescent lamp base for emitting light to the light guide bar.

The present invention further provides a light emitting device for being disposed on a fluorescent lamp base having a first socket and a second socket. The light emitting device includes alight guide bar, a first plug structure, a second plug structure, and a first LED assembly. The light guide bar has a first end and a second end corresponding to the first socket and the second socket respectively. The first plug structure is disposed on the first end of the light guide bar for electrically connecting to the first socket. The second plug structure is disposed on the second end of the light guide bar for electrically connecting to the second socket. The first LED assembly is disposed in the first plug structure and has two first cables. The two first cables are coupled to the first plug structure and the second plug structure respectively, so as to make the first LED assembly receive power provided by the fluorescent lamp base for emitting light to the light guide bar.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial exploded diagram of an illumination apparatus according to an embodiment of the present invention.

FIG. 2 is an exploded diagram of a light emitting device in FIG. 1.

FIG. 3 is a sectional view of the light emitting device in FIG. 1 along a sectional line A-A′.

FIG. 4 is a sectional view of a heat dissipating sleeve in FIG. 2 along a sectional line B-B′.

FIG. 5 is an assembly diagram of the light emitting device in FIG. 1 being installed on a fluorescent lamp base.

### DETAILED DESCRIPTION

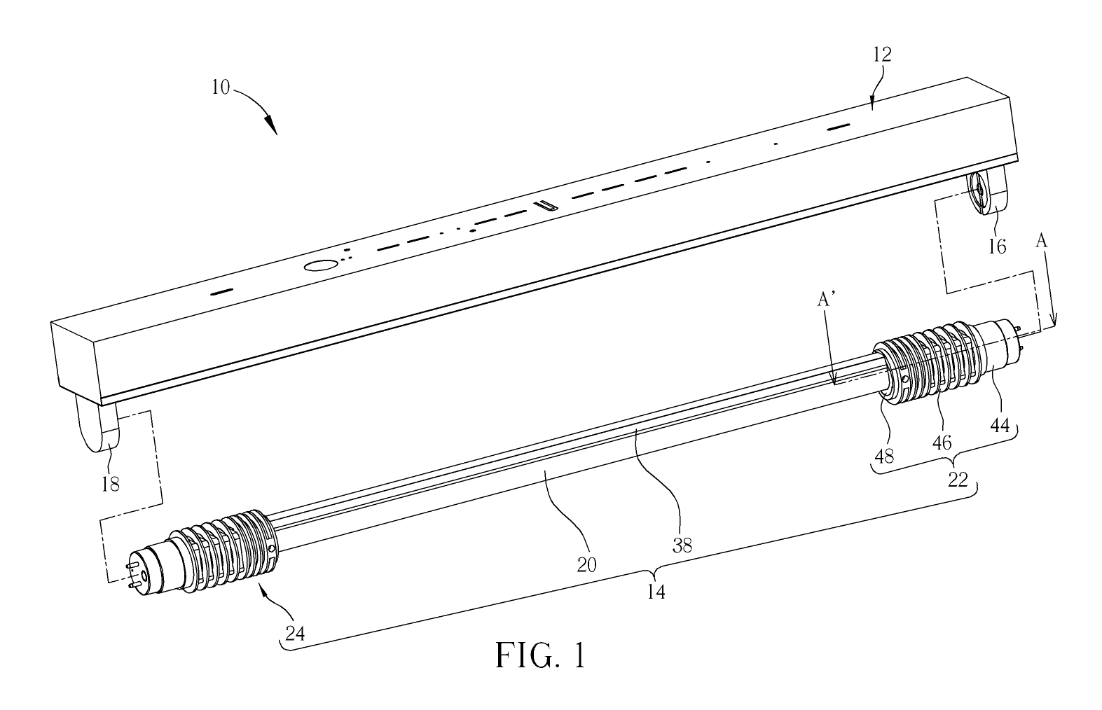

Please refer FIG. 1, which is a partial exploded diagram of an illumination apparatus 10 according to an embodiment of the present invention. The illumination apparatus 10 includes a fluorescent lamp base 12 and a light emitting device 14. The fluorescent lamp base 12 has a first socket 16 and a second socket 18. The fluorescent lamp base 12 can be a conventional lamp base having a live wire socket and a neutral wire socket for electrically connecting to lamp caps of a fluorescent lamp. The circuit design of the fluorescent lamp base 12 is commonly seen in the prior art and the related description is therefore omitted herein. The light emitting device 14 is disposed on the fluorescent lamp base 12 and electrically connected to the first socket 16 and the second socket 18 respectively, for receiving power transmitted from the fluorescent lamp base 12 via the first socket 16 and the second socket 18 to emit light.

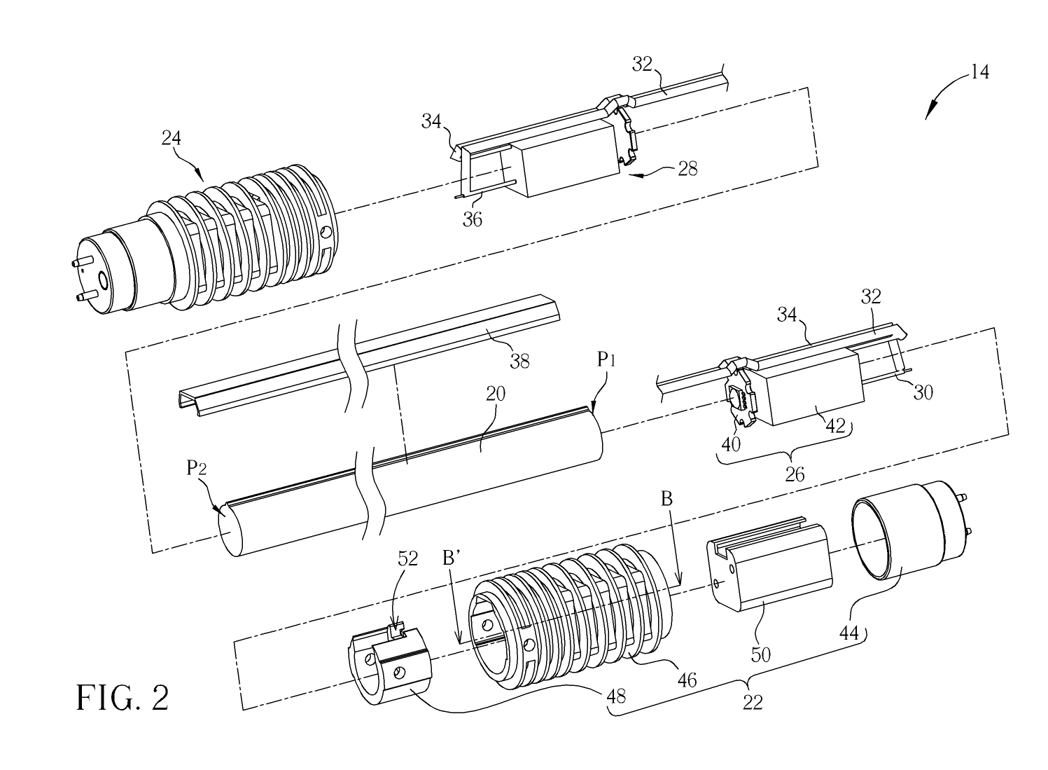

Please refer to FIG. 1 and FIG. 2. FIG. 2 is an exploded diagram of the light emitting device 14 in FIG. 1. As shown in FIG. 2, the light emitting device 14 includes a light guide bar 20, a first plug structure 22, a second plug structure 24, a first LED assembly 26, and a second LED assembly 28.

The light guide bar 20 has a first end P₁ and a second end P₂ respectively corresponding to the first socket 16 and a second socket 18. The first plug structure 22 is disposed at the first end P₁ of the light guide bar 20 for electrically connecting to the first socket 16 (as shown in FIG. 1). The second plug structure 24 is disposed at the second end P₂ of the light guide bar 20 for electrically connecting to the second socket 18. The first LED assembly 26 is disposed in the first plug structure 22 and has two first cables 30, 32. The two first cables 30, 32 are coupled to the first plug structure 22 and the second plug structure 24 respectively for establishing electrical connection of the first LED assembly 26 to the first socket 16 and the second socket 18 via the first plug structure 22 and the second plug structure 24, so that the first LED assembly 26 can receive power provided by the fluorescent lamp base 12 for emitting light to the light guide bar 20. The second LED assembly 28 is disposed in the second plug structure 24 and has two second cables 34, 36. The two second cables 34, 36 are coupled to the first plug structure 22 and the second plug structure 24 respectively for establishing electrical connection of the second LED assembly 28 to the first socket 16 and the second socket 18 via the first plug structure 22 and the second plug structure 24, so that the second LED assembly 28 can receive power provided by the fluorescent lamp base 12 for emitting light to the light guide bar 20. In such a manner, the illumination apparatus 10 can utilize the design in which light generated by the first LED assembly 26 and the second LED assembly 28 is emitted out of the light guide bar 20, to provide illumination with sufficient brightness and uniform distribution.

Furthermore, the light emitting device 14 can further include a cable hiding cover 38. As shown in FIG. 1, the cable hiding cover 38 is connected between the first plug structure 22 and the second plug structure 24 and located at a side of the light guide bar 20. The cable hiding cover 38 is used to cover the first cable 32 electrically connected to the second plug structure 24 and the second cable 34 electrically connected to the first plug structure 22 for preferable aesthetic appearance and cable protection. As for the design of connecting the cable hiding cover 38 to the first plug structure 22 and the second plug structure 24, it can adopt a common connection design, such as utilizing tapes or screws to connect the cable hiding cover 38 to the first plug structure 22 and the second plug structure 24 after the cable hiding cover 38 is inserted into the first plug structure 22 and the second plug structure 24.

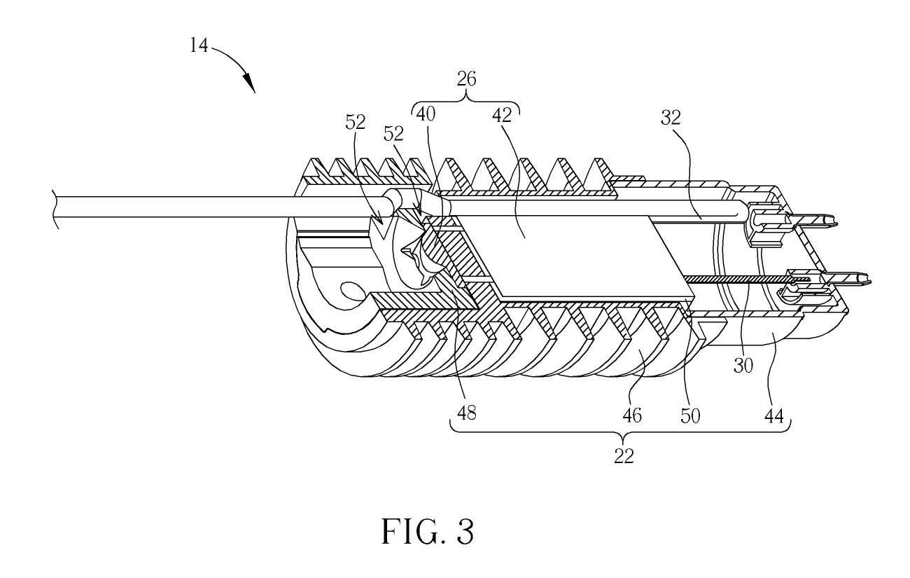

More detailed description for the structural designs of the first plug structure 22 and the first LED assembly 26 is provided as follows. As for the structural designs of the second plug structure 24 and the second LED assembly 28, they can be reasoned by analogy and the related description is therefore omitted herein for simplicity. Please refer to FIG. 3, which is a sectional view of the light emitting device 14 in FIG. 1 along a sectional line A-A′. For clearly displaying the configuration of the first cable 32 with the heat dissipating sleeve 46 and the fixing sleeve 48, the light guide bar 20 and the cable hiding cover 38 is not depicted in FIG. 3. As shown in FIG. 2 and FIG. 3, the first LED assembly 26 includes a light emitting diode 40 and a driving device 42. The first plug structure 22 includes a lamp cap 44, a heat dissipating sleeve 46, a fixing sleeve 48, and an insulation sleeve 50.

The driving device 42 is electrically connected to the light emitting diode 40 and the first cables 30, 32 for driving the light emitting diode 40 to emit light. The lamp cap 44 is electrically connected to the first cable 30 (as shown in FIG. 3). The lamp cap 44 is used for inserting into the first socket 16 to be electrically connected to the first socket 16. The heat dissipating sleeve 46 is sleeved on the light guide bar 20 and the lamp cap 44 for respectively containing the light emitting diode 40 and the driving device 42. The heat dissipating sleeve 46 is preferably made of heat conductive material (e.g. metal) and has heat dissipating fins at its outer edge (but not limited thereto) for heat dissipation. The fixing sleeve 48 is disposed between the light guide bar 20 and the heat dissipating sleeve 46 and sleeved on the light emitting diode 40 for fixing the light emitting diode 40 in the heat dissipating sleeve 46. The insulation sleeve 50 is disposed in the heat dissipating sleeve 46 and sleeved on the driving device 42. The insulation sleeve 50 is used to prevent the driving device 42 from contacting the heat dissipating sleeve 46 for electrical insulation.

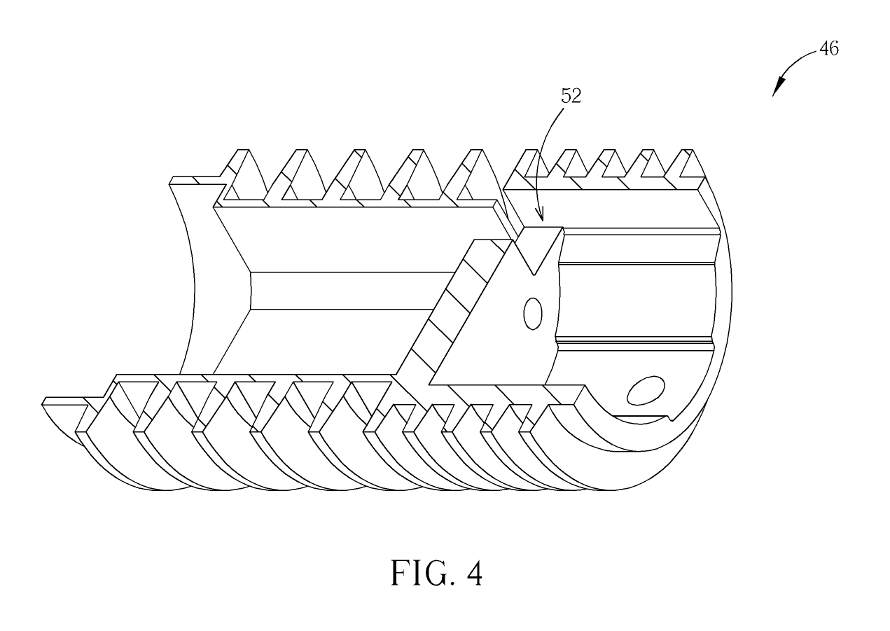

Besides, the present invention can further utilize the design in which the first cable 32 passes through the heat dissipating sleeve 46 and the fixing sleeve 48 directly to be electrically connected to the second plug structure 24. For example, please refer to FIG. 2, FIG. 3, and FIG. 4. FIG. 4 is a sectional view of the heat dissipating sleeve 46 in FIG. 2 along a sectional line B-B′. As shown in FIG. 2 and FIG. 4, the heat dissipating sleeve 46 and the fixing sleeve 48 can have a cable slot 52 respectively. Accordingly, the first cable 32 can pass through the cable slot 52 of the heat dissipating sleeve 46 and the cable slot 52 of the fixing sleeve 48 sequentially to be electrically connected to the second plug structure 24 (as shown in FIG. 3).

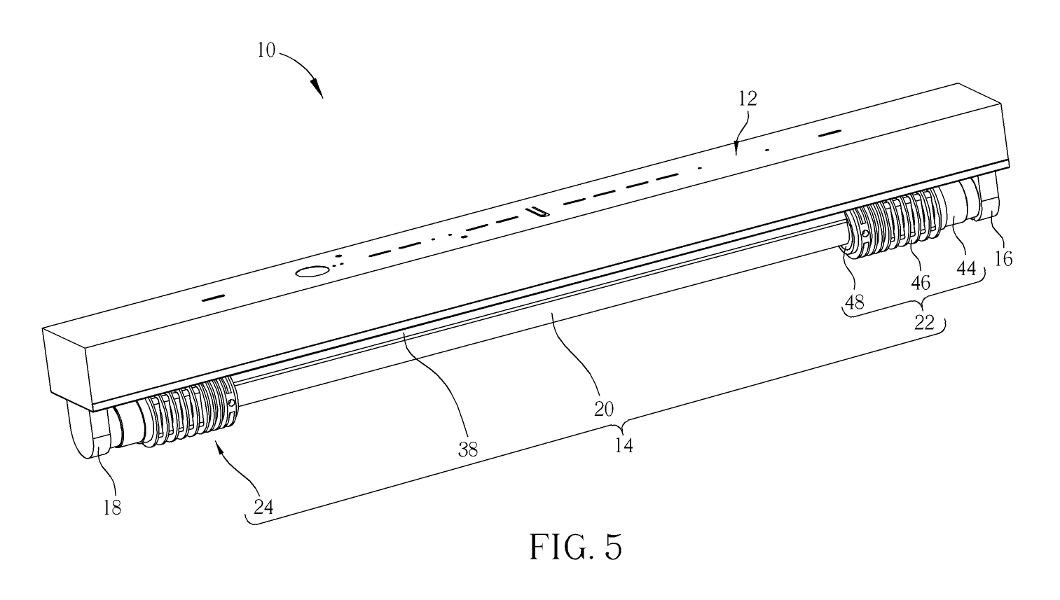

Via the aforesaid disposition, when a user wants to utilize the light emitting device 14 to replace a conventional fluorescent lamp for illumination, the user just needs to insert the first plug structure 22 and the second plug structure 24 into the first socket 16 and the second socket 18 respectively (as shown in FIG. 5, which is an assembly diagram of the light emitting device 14 in FIG. 1 being installed on the fluorescent lamp base 12), so as to complete assembly of the illumination apparatus 10. At this time, as mentioned above, the first LED assembly 26 and the second LED assembly 28 can receive power transmitted from the fluorescent lamp base 12 to emit light after the light emitting device 14 is installed on the fluorescent lamp base 12. Accordingly, light generated by the first LED assembly 26 and the second LED assembly 28 can be emitted out of the light guide bar 20 after being incident into the light guide bar 20, so that the illumination apparatus 10 can provide illumination with sufficient brightness and uniform distribution. In such a manner, the present invention can solve the problem that the light emitting device composed of the light guide bar and the light emitting diode can not be directly installed on a conventional fluorescent lamp base above-mentioned in the prior art.

It should be mentioned that the structural designs of the aforesaid LED assembly and the aforesaid plug structure are not limited to the aforesaid embodiment. In other words, all designs, in which the cables of the LED assembly are respectively coupled to the plug structures at the two ends of the light guide bar so that the light emitting device can be directly installed on the fluorescent lamp base to emit light, may fall within the scope of the present invention. Furthermore, the present invention can also utilize the design in which the LED assembly is only disposed on one end of the light guide bar, so as to simplify the structural design and the related circuit design of the illumination apparatus 10.

Compared with the prior art, the present invention utilizes the design in which the cables of the LED assembly are respectively coupled to the plug structures disposed at the two ends of the light guide bar, to make the light emitting device capable of being directly installed on a conventional fluorescent lamp base instead of a lamp base with a specific circuit configuration. In such a manner, the present invention can solve the problem that the light emitting device composed of the light guide bar and the light emitting diode can not be suitable to a conventional fluorescent lamp base. Furthermore, since there is no need to additionally utilize a lamp base with a specific circuit configuration for installation of the light emitting device, the present invention can further improve convenience of the light emitting device in use and simplify the related installation process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination apparatus comprising:
a fluorescent lamp base having a first socket and a second socket for providing power; and
a light emitting device disposed on the fluorescent lamp base and comprising:
a light guide bar having a first end and a second end corresponding to the first socket and the second socket respectively;
a first plug structure disposed on the first end of the light guide bar for electrically connecting to the first socket;
a second plug structure disposed on the second end of the light guide bar for electrically connecting to the second socket; and
a first LED assembly disposed in the first plug structure and having two first cables, and the two first cables being coupled to the first plug structure and the second plug structure respectively, so as to make the first LED assembly receive power provided by the fluorescent lamp base for emitting light to the light guide bar.

2. The illumination apparatus of claim 1, wherein the light emitting device further comprises:
a second LED assembly disposed in the second plug structure and having two second cables, and the two second cables being coupled to the first plug structure and the second plug structure respectively, so as to make the second LED assembly receive power provided by the fluorescent lamp base for emitting light to the light guide bar.

3. A light emitting device for being disposed on a fluorescent lamp base having a first socket and a second socket, the light emitting device comprising:
a light guide bar having a first end and a second end corresponding to the first socket and the second socket respectively;
a first plug structure disposed on the first end of the light guide bar for electrically connecting to the first socket;
a second plug structure disposed on the second end of the light guide bar for electrically connecting to the second socket; and
a first LED assembly disposed in the first plug structure and having two first cables, the two first cables being coupled to the first plug structure and the second plug structure respectively, so as to make the first LED assembly receive power provided by the fluorescent lamp base for emitting light to the light guide bar.

4. The light emitting device of claim 3, wherein the first LED assembly comprises a light emitting diode and a driving device, the driving device is coupled to the light emitting diode and the two first cables for driving the light emitting diode to emit light, and the first plug structure comprises:
a lamp cap for inserting into the first socket to be coupled to the first socket; and
a heat dissipating sleeve disposed between the light guide bar and the lamp cap for containing the light emitting diode and the driving device respectively, and the first cable passing through the heat dissipating sleeve to be coupled to the second plug structure.

5. The light emitting device of claim 4, wherein the heat dissipating sleeve has a cable slot, and the first cable passes through the cable slot to be coupled to the second plug structure.

6. The light emitting device of claim 4, wherein the first plug structure further comprises:
a fixing sleeve disposed between the light guide bar and the heat dissipating sleeve and sleeved on the light emitting diode, for fixing the light emitting diode in the heat dissipating sleeve, and the first cable passing through the heat dissipating sleeve and the fixing sleeve to be coupled to the second plug structure.

7. The light emitting device of claim 6, wherein the heat dissipating sleeve and the fixing sleeve have a cable slot respectively, and the first cable passes through the cable slot of the heat dissipating sleeve and the cable slot of the fixing sleeve sequentially to be coupled to the second plug structure.

8. The light emitting device of claim 4, wherein the first plug structure further comprises:
an insulation sleeve disposed in the heat dissipating sleeve and sleeved on the driving device.

9. The light emitting device of claim 3 further comprising:
a cable hiding cover connected between the first plug structure and the second plug structure and located at a side of the light guide bar, for covering the first cable coupled to the second plug structure.

10. The light emitting device of claim 3 further comprising:
a second LED assembly disposed in the second plug structure and having two second cables, and the two second cables being coupled to the first plug structure and the second plug structure respectively, so as to make the second LED assembly receive power provided by the fluorescent lamp base for emitting light to the light guide bar.

11. The light emitting device of claim 10 further comprising:
a cable hiding cover connected between the first plug structure and the second plug structure and located at a side of the light guide bar, for covering the first cable coupled to the second plug structure and the second cable coupled to the first plug structure.
